(19) United States
(12) Patent Application Publication
(10) Pub. No.: US 2025/0047110 A1
(43) Pub. Date: Feb. 6, 2025

(54) METHODS AND APPARATUS FOR BATTERY CELL MANAGEMENT

(71) Applicant: Enphase Energy, Inc., Petaluma, CA (US)

(72) Inventor: Chris Morrow YOUNG, Round Rock, TX (US)

(21) Appl. No.: 18/778,502

(22) Filed: Jul. 19, 2024

Related U.S. Application Data
(60) Provisional application No. 63/530,378, filed on Aug. 2, 2023.

(51) Int. Cl. H02J 7/00; H02J 7/34

(52) U.S. Cl. CPC H02J 7/0014; H02J 7/0048; H02J 7/0063; H02J 7/342; H02J 7/345; H02J 2207/40; H02J 2207/50

(57) ABSTRACT

A method for battery cell balancing is provided and comprises determining a capacity of battery cells in a battery pack and at least one of charging or discharging a battery cell from or to an intermediate storage which in turn transfers energy from a charging source or to a load to balance a state-of-charge/voltage of the battery cells.

### CROSS-REFERENCE TO RELATED APPLICATIONS

The present application claims the benefit of and priority to U.S. Provisional Application Ser. No. 63/530,378, filed on Aug. 2, 2023, the entire contents of which is incorporated herein by reference.

### BACKGROUND

### 1. Field of the Disclosure

Embodiments of the present disclosure generally relate to power systems and, for example, to methods and apparatus for battery cell management.

### 2. Description of the Related Art

Conventional storage systems comprise one or more batteries that can be coupled to one or more microinverters. For example, the one or more batteries can comprise one or more lithium ferrophosphate (LFP) batteries. While the LFP batteries are suitable for their intended purposes, over time manufacturing, mechanical stress, temperature, current and voltage variances can lead to safety issues especially near the LFP battery charge and discharge end points. Additionally, over time capacity erosion can lead to reduced LFP battery capacity, and capacity erosion variations can lead to shortened lifetime of the entire battery pack in which the LFP battery can be installed. With respect to capacity erosion, which is a function of many factors (e.g., C-rate, temperature, etc.) and is proportional to Coulomb or Ampere-hour (Ah) throughput, the more the throughput, the greater the erosion of capacity. Additionally, weak cells of the battery pack may tend to erode faster than strong cells of the battery pack.

Conventional methods and apparatus can use passive cell balancing (or dissipative) or active cell balancing (or non-dissipative) for cell management to reduce the effects of voltage variances and/or capacity erosion. Such methods, however, are limited in at least one of providing safety, maximizing battery pack capacity, and maximizing battery pack life.

Therefore, the inventors have provided herein improved methods and apparatus methods and apparatus for battery cell management.

### SUMMARY

In accordance with some aspects of the present disclosure there is provided a method for battery cell balancing comprising determining a capacity of battery cells in a battery pack and at least one of charging or discharging a battery cell from or to an intermediate storage which in turns transfers energy from a charging source or to a load to balance a state-of-charge/voltage of the battery cells.

In accordance with some aspects of the present disclosure there is provided a non-transitory computer readable storage medium having instructions stored thereon that when executed by a processor perform a method for battery cell balancing. The method comprising determining a capacity of battery cells in a battery pack and at least one of charging or discharging a battery cell from or to an intermediate storage which in turns transfers energy from a charging source or to a load to balance a state-of-charge/voltage of the battery cells.

In accordance with some aspects of the present disclosure there is provided an apparatus for battery cell balancing comprising a controller configured to determine a capacity of battery cells in a battery pack and at least one of charge or discharge a battery cell from or to an intermediate storage which in turns transfers energy from a charging source or to a load to balance a state-of-charge/voltage of the battery cells.

Various advantages, aspects, and novel features of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a block diagram of an AC battery system, in accordance with at least some embodiments of the present disclosure;

FIG. 3 is a diagram of battery cells during charging and discharging in accordance with at least some embodiments of the present disclosure;

FIG. 4 is a schematic diagram of an apparatus configured for use with the AC battery system of FIG. 2, in accordance with at least some embodiments of the present disclosure; and

FIG. 5 is a flowchart of a method for battery cell management, in accordance with at least some embodiments of the present disclosure.

### DETAILED DESCRIPTION

In accordance with the present disclosure, provided herein are improved methods and apparatus for battery cell management. For example, a method for battery cell balancing can comprise determining a capacity of battery cells in a battery pack and at least one of charging or discharging a battery cell from or to an intermediate storage (e.g., a magnetic core of a transformer, an inductor, and/or a dielectric of a capacitor) which in turn transfers energy from a charging source or to a load to balance a state-of-charge/voltage of the battery cells. The methods and apparatus described provide an intelligent, cost effective way of managing battery cells, and in doing so, decreases voltage variances over time and also decreases capacity erosion and capacity erosion variations over time.

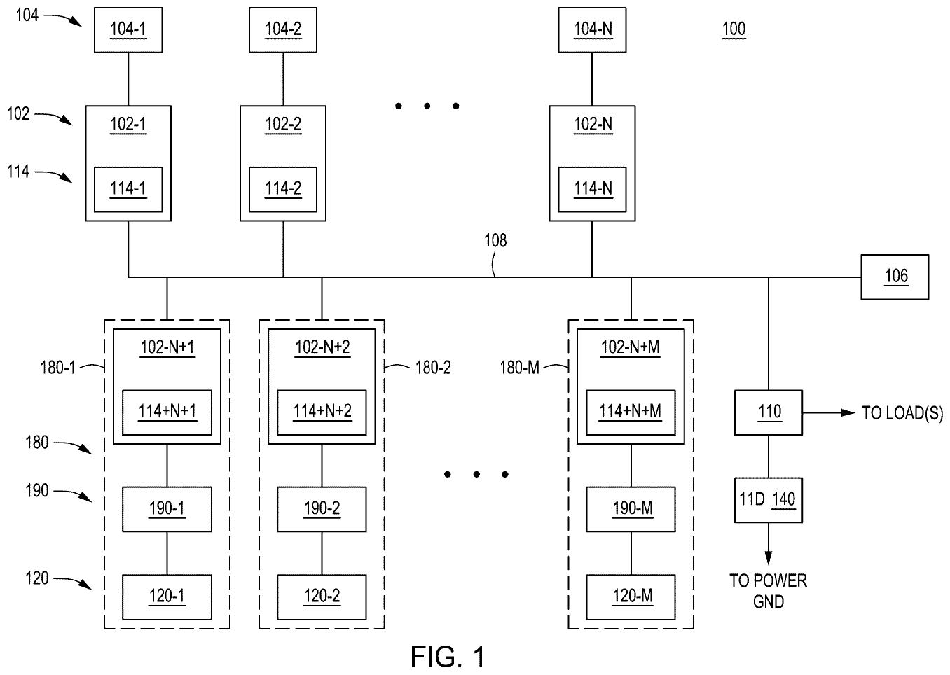

FIG. 1 is a block diagram of a system 100 (energy management system) for power conversion using one or more embodiments of the present disclosure. This diagram only portrays one variation of the myriad of possible system configurations and devices that may utilize the present disclosure.

The system 100 is a microgrid that can operate in both an islanded state and in a grid-connected state (i.e., when connected to another power grid (such as one or more other microgrids and/or a commercial power grid). The system 100 comprises a plurality of power converters 102-1, 102-2, . . . 102-N, 102-N+1, and 102-N+M collectively referred to as power converters 102 (which also may be called power conditioners); a plurality of DC power sources 104-1, 104-2, . . . 104-N, collectively referred to as power sources 104 (e.g., resources); a plurality of energy storage devices/delivery devices 120-1, 120-2, . . . 120-M collectively referred to as energy storage/delivery devices 120; a system controller 106; a plurality of BMUs 190-1, 190-2, . . . 190-M (battery management units) collectively referred to as BMUs 190; a system controller 106; a bus 108; a load center 110; and an IID 140 (island interconnect device) (which may also be referred to as a microgrid interconnect device (MID)). In some embodiments, such as the embodiments described herein, the energy storage/delivery devices are rechargeable batteries (e.g., multi-C-rate collection of AC batteries) which may be referred to as batteries 120, although in other embodiments the energy storage/delivery devices may be any other suitable device for storing energy and providing the stored energy. Generally, each of the batteries 120 comprises a plurality battery cells that are coupled in series, e.g., two or more battery cells in series to form a battery 120.

Each power converter 102-1, 102-2 . . . 102-N is coupled to a DC power source 104-1, 104-2 . . . 104-N, respectively, in a one-to-one correspondence, although in some other embodiments multiple DC power sources may be coupled to one or more of the power converters 102. The power converters 102-N+1, 102-N+2 . . . 102-N+M are respectively coupled to plurality of energy storage devices/delivery devices 120-1, 120-2 . . . 120-M via BMUs 190-1, 190-2 . . . 190-M to form AC batteries 180-1, 180-2 . . . 180-M, respectively. Each of the power converters 102-1, 102-2 . . . 102-N+M comprises a corresponding controller 114-1, 114-2 . . . 114-N+M (collectively referred to as the inverter controllers 114) for controlling operation of the power converters 102-1, 102-2 . . . 102-N+M.

In some embodiments, such as the embodiment described below, the DC power sources 104 are DC power sources and the power converters 102 are bidirectional inverters such that the power converters 102-1 . . . 102-N convert DC power from the DC power sources 104 to grid-compliant AC power that is coupled to the bus 108, and the power converters 102-N+1 . . . 102-N+M convert (during energy storage device discharge) DC power from the batteries 120 to grid-compliant AC power that is coupled to the bus 108 and also convert (during energy storage device charging) AC power from the bus 108 to DC output that is stored in the batteries 120 for subsequent use. The DC power sources 104 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. In other embodiments the power converters 102 may be other types of converters (such as DC-DC converters), and the bus 108 is a DC power bus.

The power converters 102 are coupled to the system controller 106 via the bus 108 (which also may be referred to as an AC line or a grid). The system controller 106 generally comprises a CPU coupled to each of support circuits and a memory that comprises a system control module for controlling some operational aspects of the system 100 and/or monitoring the system 100 (e.g., issuing certain command and control instructions to one or more of the power converters 102, collecting data related to the performance of the power converters 102, and the like). The system controller 106 is capable of communicating with the power converters 102 by wireless and/or wired communication (e.g., power line communication) for providing certain operative control and/or monitoring of the power converters 102.

In some embodiments, the system controller 106 may be a gateway that receives data (e.g., performance data) from the power converters 102 and communicates (e.g., via the Internet) the data and/or other information to a remote device or system, such as a master controller (not shown). Additionally or alternatively, the gateway may receive information from a remote device or system (not shown) and may communicate the information to the power converters 102 and/or use the information to generate control commands that are issued to the power converters 102.

The power converters 102 are coupled to the load center 110 via the bus 108, and the load center 110 is coupled to the power grid via the IID 140. When coupled to the power grid (e.g., a commercial grid or a larger microgrid) via the IID 140, the system 100 may be referred to as grid-connected; when disconnected from the power grid via the IID 140, the system 100 may be referred to as islanded. The IID 140 determines when to disconnect from/connect to the power grid (e.g., the IID 140 may detect a grid fluctuation, disturbance, outage or the like) and performs the disconnection/connection. Once disconnected from the power grid, the system 100 can continue to generate power as an intentional island, without imposing safety risks on any line workers that may be working on the grid, using the droop control techniques described herein. The IID 140 comprises a disconnect component (e.g., a disconnect relay) for physically disconnecting/connecting the system 100 from/to the power grid. In some embodiments, the IID 140 may additionally comprise an autoformer for coupling the system 100 to a split-phase load that may have a misbalance in it with some neutral current. In certain embodiments, the system controller 106 comprises the IID 140 or a portion of the IID 140.

The power converters 102 convert the DC power from the DC power sources 104 and discharge the batteries 120 to grid-compliant AC power and couple the generated output power to the load center 110 via the bus 108. The power is then distributed to one or more loads (for example to one or more appliances) and/or to the power grid (when connected to the power grid). Additionally or alternatively, the generated energy may be stored for later use, for example using batteries, heated water, hydro pumping, H₂O-to-hydrogen conversion, or the like. Generally, the system 100 is coupled to the commercial power grid, although in some embodiments the system 100 is completely separate from the commercial grid and operates as an independent microgrid.

In some embodiments, the AC power generated by the power converters 102 is single-phase AC power. In other embodiments, the power converters 102 generate three-phase AC power.

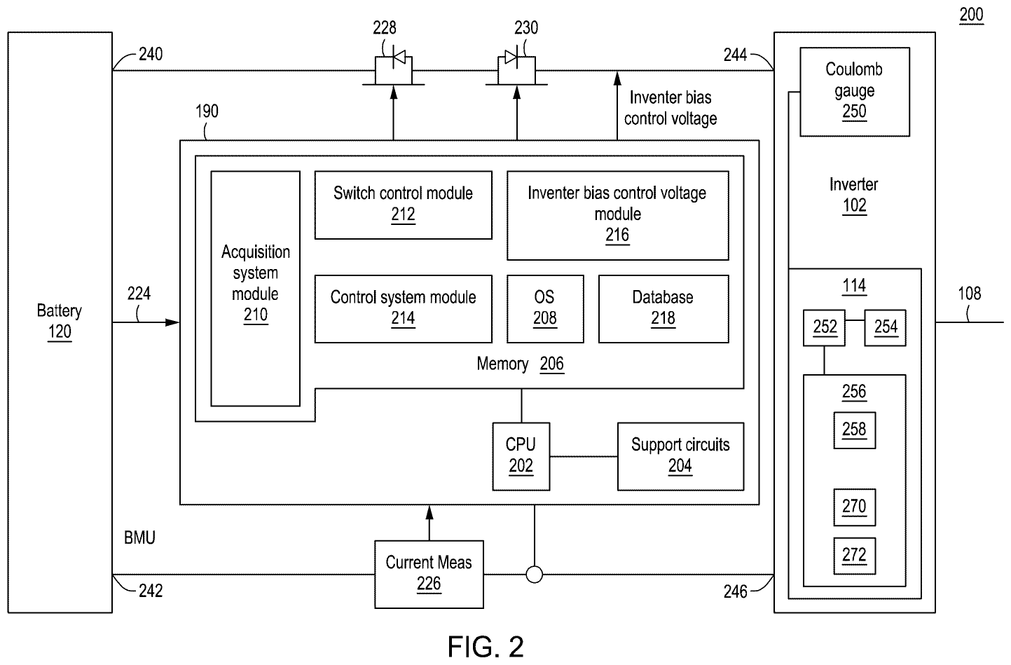

A storage system configured for use with an energy management system, such as the Enphase® Energy System, is described herein. For example, FIG. 2 is a block diagram of an AC battery system 200 (e.g., a storage system) in accordance with one or more embodiments of the present disclosure.

The AC battery system 200 comprises a BMU 190 coupled to a battery (e.g., the battery 120) and one or more inverters (e.g., the power converters 102). In at least some embodiments, the battery 120 can comprise a plurality of battery cells (not shown) and the power converters 102 can comprise four embedded converters (e.g., four embedded microinverters). In at least some embodiments, the battery 120 can be the IQ Battery 3 (or the IQ Battery 10) and the microinverters can be the IQ8X-BAT microinverters, both available from Enphase®. A pair of metal-oxide-semiconductor field-effect transistors (MOSFETs) switches—switches 228 and 230—are coupled in series between a first terminal 240 of the battery 120 and a first terminal of the inverter 144 such the body diode cathode terminal of the switch 228 is coupled to the first terminal 240 of the battery 120 and the body diode cathode terminal of the switch 230 is coupled to the first terminal 244 of the power converter 102. The gate terminals of the switches 228 and 230 are coupled to the BMU 190.

A second terminal 242 of the battery 120 is coupled to a second terminal 246 of the power converter 102 via a current measurement module 226 which measures the current flowing between the battery 120 and the power converter 102.

The BMU 190 is coupled to the current measurement module 226 for receiving information on the measured current, and also receives an input 224 from the battery 120 indicating the battery cell voltage and temperature. The BMU 190 is coupled to the gate terminals of each of the switches 228 and 230 for driving the switch 228 to control battery discharge and driving the switch 230 to control battery charge as described herein. The BMU 190 is also coupled across the first terminal 244 and the second terminal 246 for providing an inverter bias control voltage (which may also be referred to as a bias control voltage) to the inverter 102 as described further below.

The configuration of the body diodes of the switches 228 and 230 allows current to be blocked in one direction but not the other depending on state of each of the switches 228 and 230. When the switch 228 is active (i.e., on) while the switch 230 is inactive (i.e., off), battery discharge is enabled to allow current to flow from the battery 120 to the power converter 102 through the body diode of the switch 230. When the switch 228 is inactive while the switch 230 is active, battery charge is enabled to allow current flow from the power converter 102 to the battery 120 through the body diode of the switch 228. When both switches 228 and 230 are active, the system is in a normal mode where the battery 120 can be charged or discharged.

The BMU 190 comprises support circuits 204 and a memory 206 (e.g., non-transitory computer readable storage medium), each coupled to a CPU 202 (central processing unit). The CPU 202 may comprise one or more processors, microprocessors, microcontrollers and combinations thereof configured to execute non-transient software instructions to perform various tasks in accordance with embodiments of the present disclosure. The CPU 202 may additionally or alternatively include one or more application specific integrated circuits (ASICs). In some embodiments, the CPU 202 may be a microcontroller comprising internal memory for storing controller firmware that, when executed, provides the controller functionality described herein. The BMU 190 may be implemented using a general purpose computer that, when executing particular software, becomes a specific purpose computer for performing various embodiments of the present disclosure.

The support circuits 204 are well known circuits used to promote functionality of the CPU 202. Such circuits include, but are not limited to, a cache, power supplies, clock circuits, buses, input/output (I/O) circuits, and the like. The BMU 190 may be implemented using a general purpose computer that, when executing particular software, becomes a specific purpose computer for performing various embodiments of the present disclosure. In one or more embodiments, the CPU 202 may be a microcontroller comprising internal memory for storing controller firmware that, when executed, provides the controller functionality described herein.

The memory 206 may comprise random access memory, read only memory, removable disk memory, flash memory, and various combinations of these types of memory. The memory 206 is sometimes referred to as main memory and may, in part, be used as cache memory or buffer memory. The memory 206 generally stores the OS 208 (operating system), if necessary, of the inverter controller 114 that can be supported by the CPU capabilities. In some embodiments, the OS 208 may be one of a number of commercially available operating systems such as, but not limited to, LINUX, Real-Time Operating System (RTOS), and the like.

The memory 206 stores non-transient processor-executable instructions and/or data that may be executed by and/or used by the CPU 202 to perform, for example, one or more methods for discharge protection, as described in greater detail below. These processor-executable instructions may comprise firmware, software, and the like, or some combination thereof. The memory 206 stores various forms of application software, such as an acquisition system module 210, a switch control module 212, a control system module 214, and an inverter bias control module 216. The memory 206 additionally stores a database 218 for storing data related to the operation of the BMU 190 and/or the present disclosure, such as one or more thresholds, equations, formulas, curves, and/or algorithms for the control techniques described herein. In various embodiments, one or more of the acquisition system module 210, the switch control module 212, the control system module 214, the inverter bias control module 216, and the database 218, or portions thereof, are implemented in software, firmware, hardware, or a combination thereof.

The acquisition system module 210 obtains the battery cell voltage and temperature information from the battery 120 via the input 224, obtains the current measurements provided by the current measurement module 226, and provides the battery cell voltage, battery cell temperature, and measured current information to the control system module 214 for use as described herein.

The switch control module 212 drives the switches 228 and 230 as determined by the control system module 214. The control system module 214 provides various battery management functions, including protection functions (e.g., overcurrent (OC) protection, overtemperature (OT) protection, and hardware fault protection), metrology functions (e.g., averaging measured battery cell voltage and battery current over, for example, 100 ms to reject 50 and 60 Hz ripple), state of charge (SoC) analysis (e.g., coulomb gauge 250 for determining current flow and utilizing the current flow in estimating the battery SoC; synchronizing estimated SOC values to battery voltages (such as setting SoC to an upper bound, such as 100%, at maximum battery voltage; setting SoC to a lower bound, such as 0%, at a minimum battery voltage); turning off SoC if the power converter 102 never drives the battery 120 to these limits; and the like), battery cell balancing (e.g., autonomously balancing the charge across all battery cells of a battery to be equal, which may be done at the end of charge, at the end of discharge, or in some embodiments both at the end of charge and the end of discharge). By establishing upper and lower estimated SoC bounds based on battery end of charge and end of discharge, respectively, and tracking the current flow and battery cell voltage (i.e., battery voltage) between these events, the BMU 190 determines the estimated SoC.

Continuing with reference to FIG. 2, the inverter controller 114 comprises support circuits 254 and a memory 256, each coupled to a CPU 252 (central processing unit). The CPU 252 may comprise one or more processors, microprocessors, microcontrollers and combinations thereof configured to execute non-transient software instructions to perform various tasks in accordance with embodiments of the present disclosure. The CPU 252 may additionally or alternatively include one or more application specific integrated circuits (ASICs). In some embodiments, the CPU 252 may be a microcontroller comprising internal memory for storing controller firmware that, when executed, provides the controller functionality herein. The inverter controller 114 may be implemented using a general purpose computer that, when executing particular software, becomes a specific purpose computer for performing various embodiments of the present disclosure.

The support circuits 254 are well known circuits used to promote functionality of the CPU 252. Such circuits include, but are not limited to, a cache, power supplies, clock circuits, buses, input/output (I/O) circuits, and the like. The inverter controller 114 may be implemented using a general purpose computer that, when executing particular software, becomes a specific purpose computer for performing various embodiments of the present disclosure. In one or more embodiments, the CPU 252 may be a microcontroller comprising internal memory for storing controller firmware that, when executed, provides the controller functionality described herein.

The memory 256 may comprise random access memory, read only memory, removable disk memory, flash memory, and various combinations of these types of memory. The memory 256 is sometimes referred to as main memory and may, in part, be used as cache memory or buffer memory. The memory 256 generally stores the OS 258 (operating system), if necessary, of the inverter controller 114 that can be supported by the CPU capabilities. In some embodiments, the OS 258 may be one of a number of commercially available operating systems such as, but not limited to, LINUX, Real-Time Operating System (RTOS), and the like.

The memory 256 stores non-transient processor-executable instructions and/or data that may be executed by and/or used by the CPU 252. These processor-executable instructions may comprise firmware, software, and the like, or some combination thereof. The memory 256 stores various forms of application software, such as a power conversion control module 270 for controlling the bidirectional power conversion, and a battery management control module 272.

As noted above, the passive (or dissipative) battery cell balancing methods use a battery cell balancing controller that is configured to remove energy from a battery cell (over-charged) by turning on a FET connected to the battery cell. In doing so, energy in the battery cell is dissipated in the form of heat through a resistor that is connected between the battery cell and the FET. Such methods remove energy from weak battery cells (e.g., battery cells with less capacity) to allow strong battery cells (e.g., battery cells with more capacity) to catch up in terms of SoC, thus protecting the weak battery cells from overcharging, but such methods, however, also increase throughput of the weak battery cells and, therefore, accelerates capacity erosion, does not increase capacity, and results in a reduced lifetime of a battery pack due to accelerated aging of the weak battery cells. Likewise, the active (or non-dissipative) battery cell balancing methods use a battery cell balancing controller that is configured to remove energy from a battery cell (over-charged) by turning on a FET connected to the battery cell and causing energy to flow from that battery cell to a non-dissipative element such as and inductor or capacitor and then turning on another FET connected to another battery cell (under-charged) which allows the energy in the inductor or capacitor to be transferred to the receiving battery cell. In doing so, energy in the battery cell is moved from the overcharged battery cell to the under-charged battery cell. Such methods effectively remove energy from the weak battery cells or strong battery cells to balance SoC, balance SoC over the charge and discharge cycle, thus increasing the usable capacity (Cᵤ) (e.g., Cᵤ˜Ct (total capacity)), but such methods, however, also increase throughput in the battery cells and, therefore, can lead to reduced lifetime of a battery pack.

Accordingly, the control system module 214 of the BMU 190 is configured to perform balancing of the individual battery cells of the batteries 120 using improved methods and apparatus for battery cell management. For example, with respect to safety, the inventor has found that near charge and discharge limits, a weak battery cell(s) approaches a state of being overcharged or over discharged. Thus, battery cell management is critical at the charge endpoint and the discharge endpoint. Similarly, with respect to maximizing battery pack capacity, the inventor has found that given the safety limits, the weak battery cell(s) can sometimes prevent the battery pack from providing the maximum capacity, and the battery pack life is determined by the life of the weakest battery cell(s). Protecting the weak battery cell(s) may extend the battery cell life and/or the battery pack life, as described in greater detail below.

FIG. 3 is a diagram of battery cells during charging and discharging, in accordance with at least one embodiment of the present disclosure. For example, during a charging cycle, stronger battery cells 302 are charged incrementally slower than weaker battery cells 304 from the charging source since they have a larger capacity than the weak cells (see SoC 306 of stronger battery cells 302 and SoC 308 of weaker battery cells 304). For example, to incrementally charge the stronger battery cells 302, the difference between the charge state of each battery cell is first determined. Next, the charge rate of the lagging battery cell(s), e.g., the stronger battery cells, can be increased by about 1-10 A for a predetermined period of time. Next, the relative charge states can be re-determined and the process repeated as needed. The extra charging does not flow through the weak battery cells, which decreases erosion of the weak battery cells. Accordingly, extra charge is delivered from the primary (e.g., a microinverter) via an intermediate path of an inductor, a core of a transformer, or a dielectric of capacitor to each of the stronger battery cells 302 as needed to balance SoC. During a discharging cycle, the stronger battery cells 302 are discharged incrementally slower than the weaker battery cells 304 since the stronger battery cells have a higher capacity than the weaker battery cells. Accordingly, extra charge is extracted from the stronger battery cells and delivered to the load via the intermediate storage (e.g., an inductor, a core of transformer, a dielectric of a capacitor, etc.) during discharge during discharge. In doing so, charge throughput in the weaker battery cells 304 is reduced, thus prolonging the life of the weaker battery cells 304 and the battery pack. Additionally, as with a charging cycle, during a discharge cycle, the relative charge state of each battery cell can be determined and additional charge or current (e.g., 1-10 A) can be extracted from the stronger battery cells for a predetermined period of time and the extra charge can be delivered to the load bypassing the weaker battery cells.

In at least some embodiments, the control system module 214 can be configured to distinguish a weak battery cell from a strong battery cell by using one or more of a state of charge (SoC), a state of health (SoH), voltage, or a measured impedance, such as by using electro impedance spectroscopy (EIS).

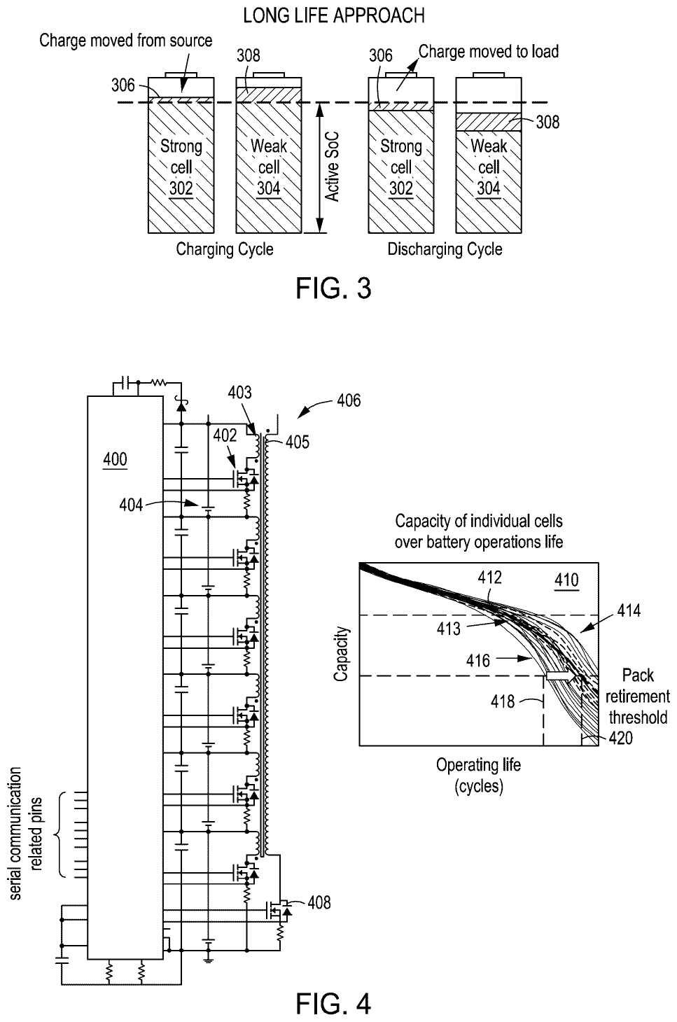

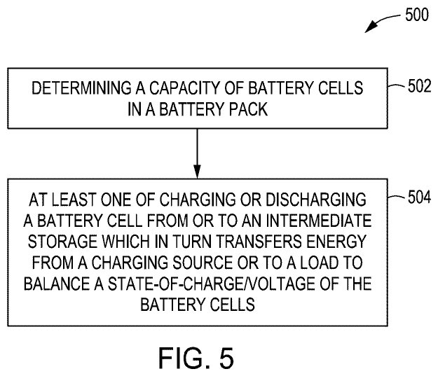

FIG. 4 is a schematic diagram of an apparatus 400 configured for use with the AC battery system of FIG. 2, and FIG. 5 is a flowchart of a method 500 for battery cell management, in accordance with at least one embodiment of the present disclosure. For example, as noted above, at 502, the method 500 can comprise determining a capacity of battery cells in a battery pack, and at 504, the method 500 can comprise at least one of charging or discharging a battery cell from or to an intermediate storage which in turn transfers energy from a charging source or to a load to balance a state-of-charge/voltage of the battery cells.

For example, the apparatus 400 can comprise one or more FETS. In at least some embodiments, depending on a control method, one or more FETs may be needed in an anti-series connection to block current in both directions when the FET is off or open. Alternatively, in at least some embodiments, a single FET can be used, e.g., when current can flow through the body diode even when the FET is off. In the illustrated embodiments, a single FET is shown coupled to corresponding battery cells 404 (e.g., six battery cells). Each of the FETS 402 and corresponding battery cells 404 are coupled to a respective primary winding 403 (six primary windings are connected in series to each other) that are coupled to a secondary winding 405 (e.g., a common secondary winding) of a transformer 406. In operation, during discharging, the battery cell balancing controller (e.g., the control system module 214) turns on one or more of the FETS of the one or more battery cells that need to be discharged (e.g., remove excess energy), and the remaining FETS are kept open. This process transfers energy from the targeted battery cell and stores the energy in a core of the transformer. After a sufficient period of time, the closed FET is opened on the primary and the secondary FET(s) is closed allowing the energy in the transformer to flow into the load. Thus, the excess energy from the one or more battery cells is routed through the controlled FET(S), to the respective primary winding 403, to the secondary winding 405, and to a corresponding load. That is, unlike conventional methods and apparatus for battery cell balancing, the excess energy is not routed through a resistor or to another battery cell. Similarly, during charging, the battery cell balancing controller turns on a main FET 408, extracts energy from the charging source and stores that energy in the core of the transformer. After a period of time, the main FET is opened and one or more of the FETS of the one or more battery cells that need to be charged are closed, while the remaining FETS are kept open. Additionally, during charging, a main FET 408 is turned on to allow energy from a power source (e.g., the DC power sources 104, another battery system, a portable energy system (PES), etc.) to be routed to the secondary winding 405, to the respective primary winding 403, through the turned on FETS, and to the battery cells.

While a single transformer is shown, the present disclosure is not so limited. For example, multiple transformers can be used. In at least some embodiments, one or more battery cells (e.g., the top three (3) battery cells) can use a first transformer and one or more other battery cells (e.g., the bottom three battery cells) can use a second transformer, which can be the same as or from the first transformer.

The methods and apparatus described herein protect weak battery cells. For example, during discharge, all the corresponding battery cells 404 can be discharged at the same dSoC/dt. The weakest battery cells discharge via a series path, and the stronger battery cells discharge via the series and parallel path. For example, the series path is the path that electrically connects the battery cells as the battery cells are connected in series, and the parallel path is the path through the transformer 406 which bypasses all of the battery cells. Likewise, during charge, all the battery cells are charged at the same dSoC/dt. The weakest battery cells charge via the series path, and the stronger battery cells charge via the series and parallel path. The methods described herein do not increase net throughput of the battery cells and can redistribute charge during storage. For example, as illustrated in the graph 410, which illustrates capacity v. operating life, the dashed lines 412 in the green area 413 is an average of the individual battery cells. For example, as illustrated in graph 410, as the operating life (e.g., cycles) of the individual battery cells increases, the capacity of the individual battery cells decreases over time (inversely proportional to each other). The grey lines 414 above the dashed lines 412 illustrate the individual relatively strong battery cells, and the grey lines 414 below the dashed lines 412 illustrate the individual relatively weak battery cells. The inventors have found that by using the battery cell balancing methods and apparatus described herein, the operating life cycle of the individual weak battery cells is increased and the overall battery pack retirement threshold can be increased (compare 418 conventional battery cell balancing methods with 420 the method 500 for battery cell balancing described herein).

The methods and apparatus described herein may be used in combination with traditional passive and/or active techniques. For example, the methods and apparatus described herein may be used in combination with traditional passive and/or active techniques while the battery is in storage, charging/discharging, or other desirable times. Also, while the present disclosure discloses using a transformer storing charge, the present disclosure is not so limited. For example, one or more other forms of controlled storage may be used, e.g., capacitors, inductors, etc.

While the foregoing is directed to embodiments of the present disclosure, other and further embodiments of the disclosure may be devised without departing from the basic scope thereof, and the scope thereof is determined by the claims that follow.

1. A method for battery cell balancing, comprising:
determining a capacity of battery cells in a battery pack; and
at least one of charging or discharging a battery cell from or to an intermediate storage which in turn transfers energy from a charging source or to a load to balance a state-of-charge/voltage of the battery cells.

2. The method of claim 1, wherein the battery cell is charged or discharged via at least one of a series and parallel path or charged or discharged via a series path only.

3. The method of claim 1, wherein during discharging the battery cell is discharged to the load.

4. The method of claim 1, wherein during charging the battery cell is charged via a power source.

5. The method of claim 4, wherein the power source is at least one of a microinverter, photovoltaic, another battery system, or a portable energy system (PES).

6. The method of claim 1, wherein the intermediate storage is at least one of a magnetic core of a transformer, an inductor, or a dielectric of a capacitor.

7. A non-transitory computer readable storage medium having instructions stored thereon that when executed by a processor perform a method for battery cell balancing, comprising:
determining a capacity of battery cells in a battery pack; and
at least one of charging or discharging a battery cell from or to an intermediate storage which in turn transfers energy from a charging source or to a load to balance a state-of-charge/voltage of the battery cells.

8. The non-transitory computer readable storage medium of claim 7, wherein the battery cell is charged or discharged via at least one of a series and parallel path or charged or discharged via a series path only.

9. The non-transitory computer readable storage medium of claim 7, wherein during discharging the battery cell is discharged to the load.

10. The non-transitory computer readable storage medium of claim 7, wherein during charging the battery cell is charged via a power source.

11. The non-transitory computer readable storage medium of claim 10, wherein the power source is at least one of a microinverter, photovoltaic, another battery system, or a portable energy system (PES).

12. The non-transitory computer readable storage medium of claim 7, wherein the intermediate storage is at least one of a magnetic core of a transformer, an inductor, or a dielectric of a capacitor.

13. An apparatus for battery cell balancing, comprising:
a controller configured to determine a capacity of battery cells in a battery pack and at least one of charge or discharge a battery cell from or to an intermediate storage which in turn transfers energy from a charging source or to a load to balance a state-of-charge/voltage of the battery cells.

14. The apparatus of claim 13, wherein the battery cell with is charged or discharged via at least one of a series and parallel path or is charged or discharged via a series path only.

15. The apparatus of claim 13, wherein during discharging the battery cell is discharged to the load.

16. The apparatus of claim 13, wherein during charging the battery cell is charged via a power source.

17. The apparatus of claim 16, wherein the power source is at least one of a microinverter, photovoltaic, another battery system, or a portable energy system (PES).

18. The apparatus of claim 13, wherein the intermediate storage is at least one of a magnetic core of a transformer, an inductor, or a dielectric of a capacitor.
